(19) United States
(12) Patent Application Publication
(10) Pub. No.: US 2026/0089660 A1
(43) Pub. Date: Mar. 26, 2026

(54) RANDOM ACCESS METHOD, APPARATUS, AND SYSTEM

(71) Applicant: HUAWEI TECHNOLOGIES CO., LTD., Shenzhen (CN)

(72) Inventors: Chuili KONG, Hangzhou (CN); Yinggang DU, Shenzhen (CN); Yu WANG, Hangzhou (CN); Feiran ZHAO, Hangzhou (CN); Jun WANG, Hangzhou (CN)

(21) Appl. No.: 19/403,510

(22) Filed: Nov. 28, 2025

Related U.S. Application Data
(63) Continuation of application No. PCT/CN2024/093924, filed on May 17, 2024.

(30) Foreign Application Priority Data
May 31, 2023 (CN) 202310639200.0

(51) Int. Cl. H04W 56/00; H04W 74/0833

(52) U.S. Cl. CPC H04W 56/002; H04W 74/0833

(57) ABSTRACT

This application provides a random access method, an apparatus, and a system, and is applied to the field of communication technologies. The random access method provided in this application includes: receiving a synchronization signal block SSB; obtaining sweeping periodicity information, where the sweeping periodicity information includes a sequence number of an SSB burst set to which the SSB belongs; and sending the sweeping periodicity information. A network device may determine a real beam position of a terminal device based on the sweeping periodicity information of the terminal device, to resolve a problem of a random access failure caused by incorrect determining of the beam position of the terminal device.

### CROSS-REFERENCE TO RELATED APPLICATIONS

This application is a continuation of International Application No. PCT/CN2024/093924, filed on May 17, 2024, which claims priority to Chinese Patent Application No. 202310639200.0, filed on May 31, 2023. The disclosures of the aforementioned applications are hereby incorporated by reference in their entireties.

### TECHNICAL FIELD

This application relates to the field of communication technologies, and in particular, to a random access method, an apparatus, and a system.

### BACKGROUND

Integration of satellite communication system and a terrestrial 5th generation (5th Generation, 5G) network leverages their respective strengths to jointly form a sea-land-space-air-ground integrated communication network with seamless global coverage, so as to meet various service requirements of users. This is an important development direction of future communication. To achieve this objective, a non-terrestrial network (non-terrestrial network, NTN) is an important technical support. An NTN system includes nodes such as a satellite network, a high-altitude platform, and an uncrewed aerial vehicle. In the NTN system, a terminal device may communicate with a base station on a satellite.

However, for the NTN system, using existing random access technologies easily causes random access failures. Therefore, how to improve a random access procedure and reduce random access failures is an urgent problem to be resolved currently.

### SUMMARY

Embodiments of this application provide a random access method, an apparatus, and a system, to reduce a random access failure.

To achieve the foregoing objective, the following technical solutions are used in embodiments of this application.

According to a first aspect, a random access method is provided. The method may be performed by a terminal device. The terminal device herein may be the terminal device itself, or may be a processor, a module, a chip, a chip system, or the like that is in the terminal device and that implements the method. The method includes: receiving a synchronization signal block SSB; obtaining sweeping periodicity information, where the sweeping periodicity information includes a sequence number of an SSB burst set to which the SSB belongs; and sending the sweeping periodicity information.

A network device may determine a real beam position of the terminal device based on the sweeping periodicity information of the terminal device, to resolve a problem of a random access failure caused by incorrect determining of the beam position of the terminal device.

In a possible design, the sweeping periodicity information is determined based on a number of a frame in which the SSB is located. Because the number of the frame is existing information, the sweeping periodicity information does not need to be additionally sent. In this way, information transmission and interaction can be reduced.

In a possible design, the sweeping periodicity information is determined based on n least significant bits of a number of a frame in which the SSB is located, where n is an integer greater than or equal to 1. In this design, less information is required for determining a sweeping periodicity, and overheads can be reduced.

In a possible design, the sweeping periodicity information is the n least significant bits of the number of the frame in which the SSB is located, where n is an integer greater than or equal to 1. In this design, the sweeping periodicity information can be directly obtained.

In a possible design, obtaining the sweeping periodicity information includes: the sweeping periodicity information is carried in a broadcast message. In this design, a sending manner and a representation form of the sweeping periodicity information may be flexibly selected.

In a possible design, the broadcast message is a system information block SIB, for example, a SIB1 or a SIB19. The design can utilize an information exchange mechanism in the existing protocol, and has better compatibility.

In a possible design, obtaining the sweeping periodicity information includes: receiving a random access response message; and determining the sweeping periodicity information based on the random access response message. In this design, the sweeping periodicity information does not need to be additionally sent, so that information transmission and interaction can be reduced.

In a possible design, determining the sweeping periodicity information based on the random access response message includes: descrambling the random access response message based on a possible value of the sweeping periodicity information and a random access radio network temporary identifier RA-RNTI, and determining the sweeping periodicity information based on a descrambling result.

In a possible design, descrambling the random access response message based on the possible value of the sweeping periodicity information and the RA-RNTI, and determining the sweeping periodicity information based on the descrambling result include: descrambling the random access response message based on RA-RNTI+i, where i is determined based on the possible value of the sweeping periodicity information; and determining the sweeping periodicity information based on a value of i that is for successful descrambling.

In a possible design, descrambling the random access response message based on the possible value of the sweeping periodicity information and the RA-RNTI, and determining the sweeping periodicity information based on the descrambling result include: descrambling the random access response message from a j^{th} bit based on the RA-RNTI, where j is determined based on the possible value of the sweeping periodicity information; and determining the sweeping periodicity information based on a value of j that is for successful descrambling.

In a possible design, sending the sweeping periodicity information includes: sending a preamble on a random access channel occasion resource, where the random access channel occasion resource and/or the preamble are/is determined based on the sweeping periodicity information. The sweeping periodicity information is implicitly indicated by using the random access channel occasion resource and/or the preamble, so that information exchange overheads can be reduced.

In a possible design, that the random access channel occasion resource and/or the preamble are/is determined based on the sweeping periodicity information includes: different possible values of the sweeping periodicity information respectively correspond to different subsets of a set including available random access channel occasion resources and/or a set including available preambles, where the subsets do not overlap; and the value of the sweeping periodicity information is one of the different possible values of the sweeping periodicity information, and the random access channel occasion resource and/or the preamble belong/belongs to the subset corresponding to the value of the sweeping periodicity information.

In a possible design, sending the sweeping periodicity information includes: the sweeping periodicity information is carried in a message 3 (Msg3). The design can utilize an information exchange mechanism in the existing protocol, and has better compatibility.

According to a second aspect, a random access method is provided. The method may be performed by a network device. The network device herein may be the network device itself, or may be a processor, a module, a chip, a chip system, or the like that is in the network device and that implements the method. The method includes: obtaining first sweeping periodicity information, where the first sweeping periodicity information includes a sequence number of a synchronization signal block SSB burst set to which a first SSB belongs; and sending a random access message at a beam position of a terminal device based on the first sweeping periodicity information. The first SSB is an SSB received by the terminal device.

The network device may determine a real beam position of the terminal device based on the first sweeping periodicity information of the terminal device, to resolve a problem of a random access failure caused by incorrect determining of the beam position of the terminal device.

In a possible design, the method further includes: sending second sweeping periodicity information, where the second sweeping periodicity information includes a sequence number of an SSB burst set to which a second SSB belongs, and the first sweeping periodicity information is determined based on one of one or more pieces of second sweeping periodicity information. The first SSB is one of one or more second SSBs. The second SSB is an SSB sent by the network device.

In a possible design, sending the second sweeping periodicity information includes: sending the second SSB, where the second sweeping periodicity information is included in a number of a frame in which the SSB is located. Because the number of the frame is existing information, the second sweeping periodicity information does not need to be additionally sent. In this way, information transmission and interaction can be reduced.

In a possible design, sending the second sweeping periodicity information includes: sending the second SSB, where the second sweeping periodicity information is included in n least significant bits of the number of the frame in which the SSB is located, and n is an integer greater than or equal to 1. In this design, less information is required for determining a sweeping periodicity, and overheads can be reduced.

In a possible design, sending the second sweeping periodicity information includes: sending the second SSB, where the second sweeping periodicity information is the n least significant bits of the number of the frame in which the SSB is located, and n is an integer greater than or equal to 1. In this design, the second sweeping periodicity information can be directly obtained.

In a possible design, the second sweeping periodicity information is carried in a broadcast message. In this design, a sending manner and a representation form of the second sweeping periodicity information may be flexibly selected.

In a possible design, the broadcast message is a system information block SIB, for example, a SIB1 or a SIB19. The design can utilize an information exchange mechanism in the existing protocol, and has better compatibility.

In a possible design, obtaining the first sweeping periodicity information includes: receiving a preamble on a random access channel occasion resource; and determining the first sweeping periodicity information based on the random access channel occasion resource and/or the preamble. The first sweeping periodicity information is implicitly indicated by using the random access channel occasion resource and/or the preamble, so that information exchange overheads can be reduced.

In a possible design, determining the first sweeping periodicity information based on the random access channel occasion resource and/or the preamble includes: different possible values of the first sweeping periodicity information respectively correspond to different subsets of a set including available random access channel occasion resources and/or a set including available preambles, where the subsets do not overlap; and determining the first sweeping periodicity information based on the subset to which the random access channel occasion resource and/or the preamble belongs.

In a possible design, the random access message is a random access response message and/or a message 4 (Msg4).

In a possible design, obtaining the first sweeping periodicity information includes: the first sweeping periodicity information is carried in a message 3 (Msg3). The design can utilize an information exchange mechanism in the existing protocol, and has better compatibility.

In a possible design, the method further includes: sending a random access response message at a plurality of possible beam positions corresponding to the terminal device. The random access response message is sent to a plurality of possible beam positions, so that a probability of receiving the random access response message by the terminal device can be increased.

In a possible design, sending the second sweeping periodicity information includes: sending a random access response message at a plurality of possible beam positions corresponding to the terminal device, and scrambling the random access response message based on a random access radio network temporary identifier RA-RNTI and the second sweeping periodicity information. In this design, the sweeping periodicity information does not need to be additionally sent, so that information transmission and interaction can be reduced.

In a possible design, scrambling the random access response message based on the RA-RNTI and the second sweeping periodicity information includes: scrambling the random access response message by using RA-RNTI+i, where i is determined based on the second sweeping periodicity information.

In a possible design, scrambling the random access response message based on an RA-RNTI and the second sweeping periodicity information includes: scrambling the random access response message from a j^{th} bit by using the RA-RNTI, where j is determined based on the second sweeping periodicity information.

According to a third aspect, a communication apparatus is provided, to implement the foregoing method. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

The communication apparatus includes a corresponding module, unit, or means (means) for implementing the foregoing method. The module, unit, or means may be implemented by hardware, software, or implemented by hardware executing corresponding software. The hardware or the software includes one or more modules or units corresponding to the foregoing functions.

According to a fourth aspect, a communication apparatus is provided, including a processor. The processor is configured to execute instructions stored in a memory, and when the processor executes the instructions, the communication apparatus is enabled to perform the method in any one of the foregoing aspects. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

In a possible design, the communication apparatus further includes the memory, and the memory is configured to store computer instructions. Optionally, the processor and the memory are integrated together, or the processor and the memory are separately disposed.

In a possible design, the memory is coupled to the processor, and is outside the communication apparatus.

According to a fifth aspect, a communication apparatus is provided, including a processor and an interface circuit. The interface circuit is configured to communicate with a module other than the communication apparatus. The processor is configured to perform the method in any one of the foregoing aspects by using a logic circuit or by running a computer program or instructions. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

Alternatively, the interface circuit may be a code/data read/write interface circuit. The interface circuit is configured to receive computer-executable instructions (the computer-executable instructions are stored in a memory, and may be directly read from the memory, or may be read by using another component) and transmit the computer-executable instructions to the processor, so that the processor is enabled to run the computer-executable instructions to perform the method in any one of the foregoing aspects.

In some possible designs, the communication apparatus may be a chip or a chip system.

According to a sixth aspect, a computer-readable storage medium is provided. The computer-readable storage medium stores instructions, and when the instructions are run on a communication apparatus, the communication apparatus is enabled to perform the method in any one of the foregoing aspects. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

According to a seventh aspect, a computer program product including instructions is provided. When the computer program product runs on a communication apparatus, the communication apparatus is enabled to perform the method in any one of the foregoing aspects. The communication apparatus may be the terminal device in the first aspect, an apparatus including the terminal device, or an apparatus included in the terminal device, such as a chip. Alternatively, the communication apparatus may be the network device in the second aspect, an apparatus including the network device, or an apparatus included in the network device.

According to an eighth aspect, a communication apparatus (for example, the communication apparatus may be a chip or a chip system) is provided. The communication apparatus includes a processor, configured to implement the function in any one of the foregoing aspects. In a possible design, the communication apparatus further includes a memory, and the memory is configured to store necessary program instructions and data. When being a chip system, the communication apparatus may include a chip, or may include a chip and another discrete component.

According to a ninth aspect, a communication system is provided. The communication system includes a terminal device and a network device. The terminal device is configured to perform the method in the first aspect. The network device is configured to perform the method in the second aspect.

For technical effects brought by any one of the design manners according to the third aspect to the ninth aspect, refer to technical effects brought by different design manners according to the first aspect or the second aspect. Details are not described herein again.

### BRIEF DESCRIPTION OF DRAWINGS

FIG. 1 is a diagram of a network architecture of an NTN system according to an embodiment of this application;

FIG. 2 is a diagram of a broadcast beam according to an embodiment of this application;

FIG. 3 is a diagram of a structure of a communication system according to an embodiment of this application;

FIG. 4 is a diagram of structures of a network device and a terminal device according to an embodiment of this application;

FIG. 5 is a diagram of another structure of a terminal device according to an embodiment of this application;

FIG. 6 is a schematic interaction diagram of a random access method according to an embodiment of this application;

FIG. 7 is a schematic interaction diagram of a random access method according to an embodiment of this application;

FIG. 8 is a schematic interaction diagram of a random access method according to an embodiment of this application;

FIG. 9 is a schematic interaction diagram of a random access method according to an embodiment of this application; and

FIG. 10 is a diagram of a structure of a communication apparatus according to an embodiment of this application.

### DESCRIPTION OF EMBODIMENTS

For ease of understanding of the technical solutions in embodiments of this application, the following first briefly describes technologies related to this application.

### 1. NTN System

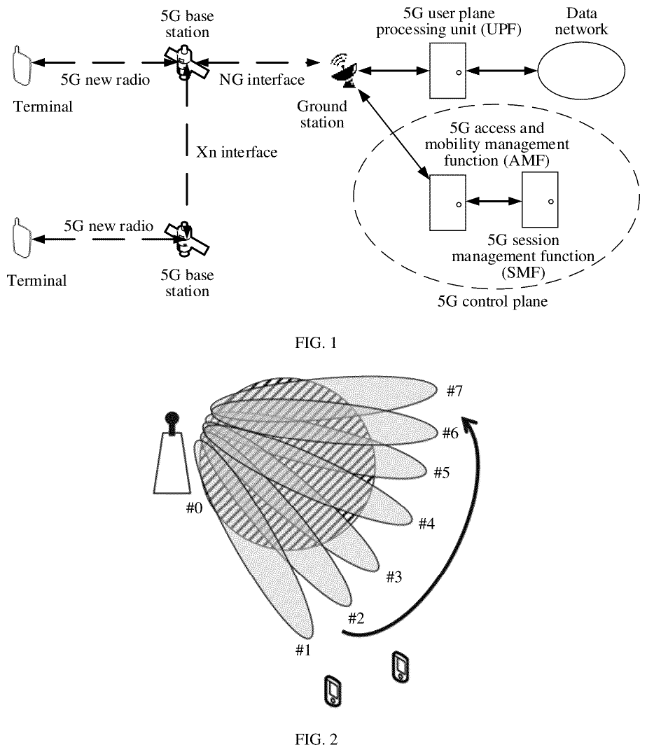

The NTN system includes nodes such as a satellite network, a high-altitude platform, and an uncrewed aerial vehicle. Currently, for a network architecture of an NTN system that integrates satellite communication and a 5G technology, refer to FIG. 1. As shown in FIG. 1, terminal devices on the ground access a network through 5G new radio. 5G base stations are deployed on satellites and are connected to a 5G core network on the ground over a radio link. In addition, a radio link exists between the satellites, to complete signaling exchange and user data transmission between the base stations on different satellites. Network elements in FIG. 1 and interfaces between the network elements are briefly described as follows.

Terminal device: The terminal device is a wireless communication device that supports the 5G new radio, for example, may be a mobile device such as a mobile phone. In the NTN system, the terminal device may access the satellite network through the 5G new radio and initiate a service such as a call or internet access.

5G base station: The 5G base station is mainly responsible for providing a wireless access service, scheduling a radio resource, and providing a reliable wireless transmission protocol, a reliable data encryption protocol, and the like for the terminal device.

5G core network: The 5G core network is mainly responsible for services such as user access control, mobility management, session management, user security authentication, and charging. The core network includes a plurality of functional units, which may be classified into a control plane functional entity and a data plane functional entity.

Data network: The data network is an operator network that provides a data transmission service for the terminal device.

Ground station: The ground station is mainly responsible for forwarding signaling and service data between the 5G base station on the satellite and the 5G core network on the ground.

5G new radio: The 5G new radio is a radio link between the terminal device and the base station.

Xn interface: The Xn interface is an interface between the 5G base stations, and is mainly configured to exchange signaling such as handover signaling.

NG interface: The NG interface is an interface between the 5G base station and the 5G core network, and is mainly configured to exchange core network signaling and user service data.

### 2. Random Access (Random Access, RA)

In the random access, that a terminal device completes uplink synchronization and switches from an idle state to a connected state is an important part in communication. The random access may be classified into contention-based random access (contention-based random access, CBRA) and contention-free random access (contention-Free Random Access, CFRA). A contention based random access procedure means that a network device does not assign a dedicated preamble (preamble) and/or a physical random access channel (physical random access channel, PRACH) resource for a terminal device, instead, the terminal device randomly selects a preamble within a specified range and initiates random access. A contention-free random access procedure means that a terminal device initiates, based on an indication of a network device, random access on a specified PRACH resource by using a specified preamble.

According to different steps of exchanging information, random access may be classified into 4-step random access (4-step random access channel, 4-step RACH) and 2-step random access (2-step random access channel, 2-step RACH). 2-step random access combines information exchange steps in 4-step random access, which reduces steps and time required for random access procedure compared with 4-step random access.

The following describes a contention-based random access with 4-step random access type (CBRA with 4-step RA type), which includes the following four steps.
Step 1: The terminal device sends a preamble to the network device on a PRACH resource. This is also referred to as sending a message 1 (message1, Msg1). The PRACH resource is determined based on system information (system information) sent by the network device in a broadcast manner. When performing initial access or needing to re-access a network, the terminal device may perform downlink synchronization, and receive random access-related configuration information in the system information broadcast by the network device.
Step 2: After receiving the Msg1 sent by the terminal device, the network device sends a message 2 (message2, Msg2) to the terminal device based on a random access preamble sent by the terminal device. The Msg2 is also referred to as a random access response (random access response, RAR) message, and is a response of the network device to the received Msg1. The Msg2 includes configuration information such as a time-frequency resource position and a modulation and coding scheme that are used for sending a Msg3 by the terminal device.
Step 3: After receiving the Msg2, the terminal device sends the message 3 (message3, Msg3) to the network device on a corresponding time-frequency resource based on the configuration information in the Msg2. The Msg3 is used for contention resolution. If a plurality of different terminal devices use a same random access preamble to perform random access, whether a conflict exists may be determined by using both the Msg3 and a Msg4. Transmission content of the Msg3 is a higher layer message, and the content of the Msg3 is not fixed. For example, the Msg3 may be a radio resource control (Radio Resource Control, RRC) connection setup request message. Currently, the Msg3 is defined in a protocol as a part of a random access procedure, and is transmitted on an uplink-shared channel (uplink-shared channel, UL-SCH). The Msg3 includes a cell-radio network temporary identifier (cell-radio network temporary identifier, C-RNTI), a media access control protocol (media access control, MAC) control element (control element, CE), or a common control channel (common control channel, CCCH) service data unit (service data unit, SDU), which is submitted by an upper layer and is associated with a contention resolution identity of the terminal device.
Step 4: After receiving the Msg3, the network device replies the message 4 (message4, Msg4) to the terminal device. Information content included in the Msg4 is not fixed, and needs to correspond to the information content included in the Msg3, to be jointly used for the contention resolution. For example, it is assumed that the Msg3 sent by the terminal device includes the CCCH SDU. Correspondingly, if the terminal device detects, in the Msg4, the CCCH SDU sent by the terminal device in the Msg3, it is considered that the contention-based random access succeeds, and a subsequent communication process continues to be performed. For another example, it is assumed that the Msg3 includes the RRC connection setup request message, the corresponding Msg4 may be one of the following two messages: an RRC connection reject message or an RRC connection setup message.

The following describes a contention-based random access with two-step random access type (CBRA with 2-step RA type), which includes the following two steps.
Step A: The terminal device sends a preamble and a physical uplink shared channel (physical uplink shared channel, PUSCH) payload (payload) to the network device. This is also referred to as sending a message A (messageA, MsgA).
Step B: The network device sends a contention resolution message to the terminal device. The contention resolution message may also be referred to as a message B (messageB, MsgB) or an RAR message.

The MsgA provides functions of the Msg1 and the Msg3, and the MsgB provides functions of the Msg2 and the Msg4.

The following describes a contention-free random access with 4-step random access type (CFRA with 4-step RA type), which includes the following three steps.
Step 0: The network device sends random access preamble assignment (RA preamble assignment) information to the terminal device.
Step 1: The terminal device sends a preamble to the network device.
Step 2: The network device sends an RAR message to the terminal device.

The following describes a contention-free random access with 2-step random access type (CFRA with 2-step RA type), which includes the following three steps.
Step 0: The network device sends a preamble and PUSCH assignment information to the terminal device.
Step A: The terminal device sends a preamble and a PUSCH payload to the network device.
Step B: The network device sends an RAR message to the terminal device.
   3. Beam (beam)

The beam is a physical beam sent by a radio frequency module of a network device. Energy may be concentrated in a specific angle range by a component like a phased array antenna or a parabolic antenna through beamforming for transmission. Electromagnetic waves are carried on the beam, and information used for communication is carried on the electromagnetic wave. A plurality of beams may be configured for one network device, and are distinguished by using beam IDs. An 18B base station in 5G new radio (new radio, NR) is used as an example. As shown in FIG. 2, a broadcast beam configuration used by the 18B base station is in a 7+1 manner, to be specific, seven narrow beams and one wide beam, to complete sweeping of a coverage area.

### 4. Beam Position

The beam position is also referred to as a beam direction, and is an area specified on the ground. Generally, the area needs to be covered by a corresponding beam.

In a scenario in which a network device is stationary, for example, in an NR system, an area covered by one beam may be considered to be corresponding to one beam position. Because the network device does not move, if one beam covers one beam position, for the network device, a beam is in one-to-one correspondence with a beam position. In other words, a synchronization signal block (synchronization signal block, SSB) index (index) may be considered as being associated with (or bound to) the beam position, or may be considered as being associated with the beam, and the two cases have a same result. However, in a scenario in which the network device is not stationary, for example, in a satellite scenario, a satellite base station moves at a high speed, and if the satellite base station covers a fixed area to implement staring, the satellite needs to adjust a beam direction to serve a fixed beam position. The beam and the beam position are two independent concepts. Results are different for cases in which the SSB index is associated with the beam and the SSB index is associated with the beam position. The SSB index being associated with the beam is a satellite-fixed (satellite-fixed) manner, and the SSB index being associated with the beam position is an earth-fixed (earth-fixed) manner.

For a broadcast beam in a satellite-fixed scenario, each beam may be bound to one SSB index, and this is easy to implement for a satellite. During sweeping, a coverage area of the satellite is gradually switched. The following cases may exist.
(1) A plurality of beam positions correspond to a same SSB index. For example, in an SSB sweeping periodicity 1, a beam 1 of a network device corresponds to a beam position 1, and the network device delivers an SSB index 1 to the beam position 1. Because the network device moves, coverage area switching occurs. In an SSB sweeping periodicity 2, the beam 1 of the network device corresponds to a beam position 2, and the network device delivers the SSB index 1 to the beam position 2. Both terminal devices at the beam position 1 and the beam position 2 send a preamble (also referred to as a Msg1) based on an RO corresponding to the SSB index 1. After receiving the preamble, the network device delivers an RAR message to the beam position 2. In this case, the terminal device at the beam position I cannot receive the RAR, causing an access failure.
(2) A same beam position corresponds to a plurality of SSB indexes. For example, a beam position 2 corresponds to an SSB index 2, and after coverage area switching occurs, the beam position 2 corresponds to an SSB index 1, and a beam position 3 corresponds to an SSB index 2. A part of terminal devices at the beam position 2 sends a preamble based on an RO corresponding to the SSB index 2, and a part of terminal devices sends a preamble based on an RO corresponding to the SSB index 1. A network device separately delivers an RAR to the beam position 2 and the beam position 3 based on the preamble. In this case, a part of the terminal devices at the beam position 2 cannot receive the RAR delivered to the beam position 3, causing an access failure.

In conclusion, when a network device performs coverage area switching in a random access procedure, the network device incorrectly determines a beam position of a part of terminal devices, causing an access failure. Therefore, it is important to perform corresponding technical enhancement on random access, so that the network device correctly identifies a beam position of the terminal device.

The following describes the technical solutions in embodiments of this application with reference to the accompanying drawings in embodiments of this application. In descriptions of this application, unless otherwise specified, “/” represents an “or” relationship between associated objects. For example, A/B may represent A or B. In this application, “and/or” describes only an association relationship for describing associated objects and represents that three relationships may exist. For example, A and/or B may represent the following three cases: Only A exists, both A and B exist, and only B exists, where A or B may be singular or plural. In addition, in the descriptions of this application, unless otherwise specified, “a plurality of” means two or more than two. In addition, to clearly describe the technical solutions in embodiments of this application, terms such as first and second are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference. In addition, in embodiments of this application, terms such as “example” or “for example” are used to represent giving an example, an illustration, or a description. Any embodiment or design scheme described as an “example” or “for example” in embodiments of this application should not be explained as being more preferred or having more advantages than another embodiment or design scheme. Exactly, use of the terms such as “example” or “for example” is intended to present a related concept in a specific manner for ease of understanding.

It should be noted that the network architecture and the service scenario described in embodiments of this application are intended to describe the technical solutions in embodiments of this application more clearly, and do not constitute a limitation on the technical solutions provided in embodiments of this application. A person of ordinary skill in the art may know that: With the evolution of the network architecture and the emergence of new service scenarios, the technical solutions provided in embodiments of this application are also applicable to similar technical problems.

The random access method provided in embodiments of this application may be applicable to various communication systems. For example, the random access method provided in embodiments of this application may be applied to a Long Term Evolution (long term evolution, LTE) system, a 5G system, an NTN system, or another new similar communication system for the future, for example, a 6th generation (6th generation, 6G) system. This is not specifically limited in this embodiment of this application. In addition, the terms “system” and “network” may be interchanged.

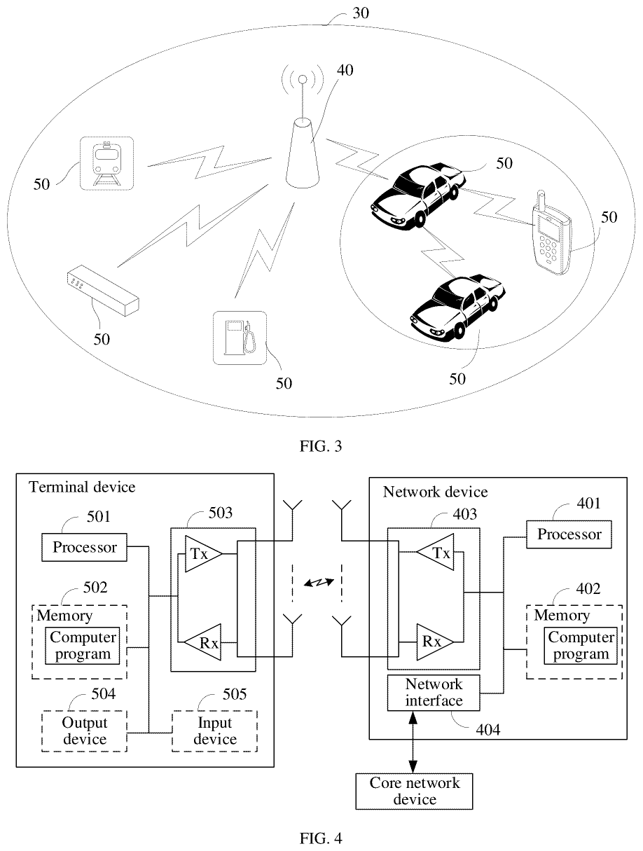

FIG. 3 shows a communication system 30 according to an embodiment of this application. The communication system 30 includes a network device 40 and one or more terminal devices 50. The terminal device 50 may communicate with the network device 40 in a wireless manner. Optionally, different terminal devices 50 may communicate with each other. The terminal device 50 may be located at a fixed position, or may be mobile.

It should be noted that FIG. 3 is merely a diagram. Although not shown, the communication system 30 may further include another network device. For example, the communication system 30 may further include one or more of a core network device, a wireless relay device, and a wireless backhaul device. This is not specifically limited herein. The network device may be connected to the core network device in a wireless or wired manner. The core network device and the network device 40 may be different independent physical devices, functions of the core network device and logical functions of the network device 40 may be integrated into a same physical device, or a part of the functions of the core network device and a part of the functions of the network device 40 may be integrated into one physical device. This is not specifically limited in this embodiment of this application.

An example in which the network device 40 shown in FIG. 3 interacts with any terminal device 50 is used, in the random access method provided in embodiments of this application, the terminal device 50 is configured to obtain first configuration information, where the first configuration information indicates a maximum quantity of repeated sending times of a preamble, and the maximum quantity of repeated sending times of the preamble is greater than 200. The terminal device 50 is further configured to send one or more preambles to the network device 40 based on the first configuration information. Specific implementation and technical effects of this solution are described in detail in subsequent method embodiments, and details are not described.

Optionally, the communication system 30 shown in FIG. 3 may be used in the network architecture shown in FIG. 1. This is not specifically limited in this embodiment of this application.

For example, if the communication system shown in FIG. 3 is used in the network architecture shown in FIG. 1, the terminal device 50 in FIG. 3 may be the terminal device in the network architecture shown in FIG. 1. The network device 40 in FIG. 3 may be the 5G base station in the network architecture shown in FIG. 1. This is not specifically limited in this embodiment of this application.

Optionally, the network device in embodiments of this application is a device that connects a terminal device to a wireless network. The network device in embodiments of this application may include base stations (base stations) in various forms, for example, may be a macro base station, a micro base station (also referred to as a small cell), a relay station, an access point, a transmitting point (transmitting point, TP), an evolved NodeB (evolved NodeB, eNodeB), a transmission reception point (transmission reception point, TRP), a next generation NodeB (next generation NodeB, gNB) in a 5G mobile communication system, a device that implements a base station function in a communication system evolved after 5G, a mobile switching center, or a device that performs a base station function in device-to-device (Device-to-Device, D2D), vehicle-to-everything (vehicle-to-everything, V2X), or machine-to-machine (machine-to-machine, M2M) communication, may be a network device in an NTN communication system, in other words, may be deployed on a high-altitude platform or a satellite, or may be a module or a unit that completes some functions of a base station, for example, may be a central unit (central unit, CU) or a distributed unit (distributed unit, DU) in a cloud access network (cloud radio access network, C-RAN) system. A specific technology and a specific device form that are used by the network device are not limited in embodiments of this application. All or some functions of the network device may alternatively be implemented by using a software function running on hardware, or may be implemented by using a virtualization function instantiated on a platform (for example, a cloud platform). In this application, unless otherwise specified, the network device is a radio access network device.

Optionally, the terminal device in embodiments of this application may be a device having a wireless transceiver function, or may be referred to as a terminal (terminal). The terminal device may be specifically user equipment, an access terminal, a subscriber unit (subscriber unit), a subscriber station, a mobile station (mobile station), customer-premises equipment (customer-premises equipment, CPE), a remote station, a remote terminal, a mobile device, a mobile terminal, a user terminal, a wireless communication device, a user agent, a user apparatus, or the like. The terminal device may alternatively be a satellite phone, a cellular phone, a smartphone, a cordless phone, a session initiation protocol (session initiation protocol, SIP) phone, a wireless data card, a wireless modem, a tablet computer, a computer with a wireless transceiver function, a wireless local loop (wireless local loop, WLL) station, a personal digital assistant (personal digital assistant, PDA), a handheld device with a wireless communication function, a computing device or another processing device connected to a wireless modem, a vehicle-mounted device, a communication device on a high-altitude aircraft, a wearable device, an uncrewed aerial vehicle, a robot, an intelligent point of sale (point of sale, POS) machine, a machine type communication device, a terminal device in D2D, a terminal device in V2X, a terminal device in virtual reality (virtual reality, VR), a terminal device in augmented reality (augmented reality, AR), a wireless terminal in industrial control (industrial control), a wireless terminal in self-driving (self-driving), a wireless terminal in telemedicine (telemedicine), a wireless terminal in a smart grid (smart grid), a wireless terminal in transportation security (transportation safety), a wireless terminal in a smart city (smart city), a wireless terminal in a smart home (smart home), a terminal device in a future communication network, or the like. Neither of a specific technology and a specific device form used by the terminal device is limited in embodiments of this application. All or some functions of the terminal device may alternatively be implemented by using a software function running on hardware, or may be implemented by using a virtualization function instantiated on a platform (for example, a cloud platform).

Optionally, in embodiments of this application, the network device and the terminal device may be deployed on land, including an indoor device, an outdoor device, a handheld device, or a vehicle-mounted device; may be deployed on water; or may be deployed on an airplane, a balloon, and a satellite in the air. Application scenarios of the network device and the terminal device are not limited in embodiments of this application.

Optionally, the network device and the terminal device in embodiments of this application may communicate with each other through a licensed spectrum, may communicate with each other through an unlicensed spectrum, or may communicate with each other through both a licensed spectrum and an unlicensed spectrum. The network device and the terminal device may communicate with each other through a spectrum below 6 gigahertz (gigahertz, GHz), may communicate with each other through a spectrum above 6 GHz, or may communicate with each other through both a spectrum below 6 GHz and a spectrum above 6 GHz. A spectrum resource used between the network device and the terminal device is not limited in embodiments of this application.

Optionally, the network device and the terminal device in embodiments of this application may also be referred to as communication apparatuses, and each may be a general-purpose device or a dedicated device. This is not specifically limited in this embodiment of this application.

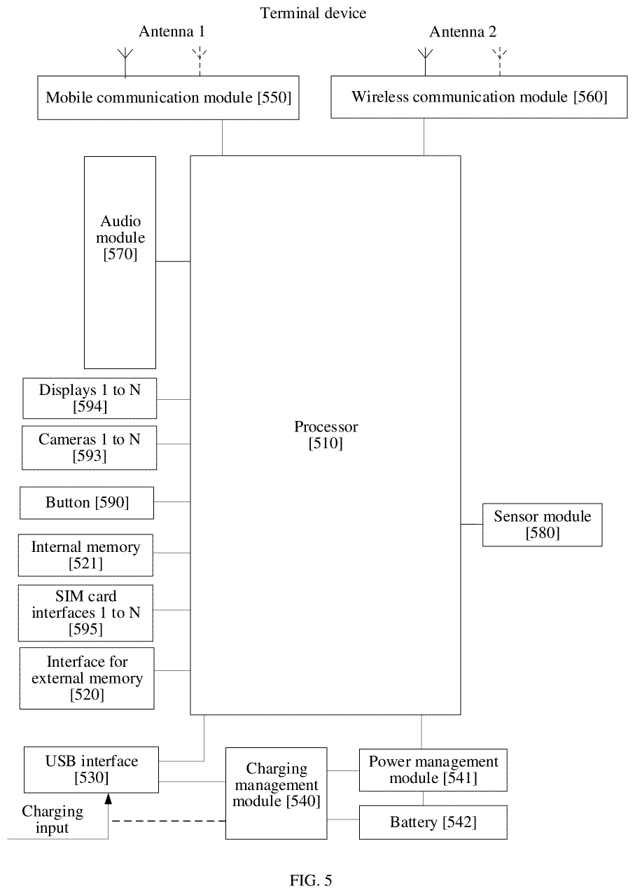

Optionally, FIG. 4 is a diagram of structures of a network device and a terminal device according to an embodiment of this application. The terminal device 50 in FIG. 3 may use a structure of the terminal device shown in FIG. 4, and the network device 40 in FIG. 3 may use a structure of the network device shown in FIG. 4.

The terminal device includes at least one processor 501 and at least one transceiver 503. Optionally, the terminal device may further include at least one memory 502, at least one output device 504, or at least one input device 505.

The processor 501, the memory 502, and the transceiver 503 are connected through a communication line. The communication line may include a path for transmitting information between the foregoing components.

The processor 501 may be a general-purpose central processing unit (central processing unit, CPU), another general-purpose processor, a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The general-purpose processor may be a microprocessor or any regular processor. During specific implementation, as an embodiment, the processor 501 may further include a plurality of CPUs, and the processor 501 may be a single-core processor or a multi-core processor. The processor herein may be one or more devices, circuits, or processing cores configured to process data.

The memory 502 may be an apparatus having a storage function, for example, may be a read-only memory (read-only memory, ROM) or another type of static storage device that can store static information and instructions, a random access memory (random access memory, RAM) or another type of dynamic storage device that can store information and instructions, or may be a programmable read-only memory (programmable ROM, PROM), an erasable programmable read-only memory (erasable PROM, EPROM), an electrically erasable programmable read-only memory (electrically erasable programmable read-only memory, EEPROM), a compact disc read-only memory (compact disc read-only memory, CD-ROM) or another compact disk storage, an optical disk storage (including a compact disc, a laser disc, an optical disc, a digital versatile disc, a Blu-ray disc, or the like), a magnetic disk storage medium or another magnetic storage device, or any other medium that can be used to carry or store expected program code in a form of instructions or a data structure and that can be accessed by a computer. However, this is not limited thereto. The memory 502 may exist independently, and is connected to the processor 501 through the communication line. Alternatively, the memory 502 and the processor 501 may be integrated together.

The memory 502 is configured to store computer-executable instructions for executing the solutions of this application, and the processor 501 controls the execution. Specifically, the processor 501 is configured to execute the computer-executable instructions stored in the memory 502, to implement the random access method in this embodiment of this application.

Alternatively, optionally, in this embodiment of this application, the processor 501 may perform a processing-related function in the random access method provided in the following embodiment of this application, and the transceiver 503 is responsible for communicating with another device or a communication network. This is not specifically limited in this embodiment of this application.

Optionally, the computer-executable instructions in embodiments of this application may also be referred to as application program code or computer program code. This is not specifically limited in this embodiment of this application.

The transceiver 503 may use any transceiver-type apparatus, and is configured to communicate with another device or a communication network such as the Ethernet, a radio access network (radio access network, RAN), or a wireless local area network (wireless local area network, WLAN). The transceiver 503 includes a transmitter (transmitter, Tx) and a receiver (receiver, Rx).

The output device 504 communicates with the processor 501, and may display information in a plurality of manners. For example, the output device 504 may be a liquid crystal display (liquid crystal display, LCD), a light emitting diode (light emitting diode, LED) display device, a cathode ray tube (cathode ray tube, CRT) display device, a projector (projector), or the like.

The input device 505 communicates with the processor 501, and may accept user input in a plurality of manners. For example, the input device 505 may be a mouse, a keyboard, a touchscreen device, a sensing device, or the like.

The network device includes at least one processor 401, at least one transceiver 403, and at least one network interface 404. Optionally, the network device may further include at least one memory 402. The processor 401, the memory 402, the transceiver 403, and the network interface 404 are connected through the communication line. The network interface 404 is configured to connect to a core network device through a link (for example, an S1 interface), or connect to a network interface of another network device through a wired or wireless link (for example, an X2 interface) (not shown in FIG. 4). This is not specifically limited in this embodiment of this application. In addition, for related descriptions about the processor 401, the memory 402, and the transceiver 403, refer to the descriptions about the processor 501, the memory 502, and the transceiver 503 in the terminal device. Details are not described herein again.

With reference to the diagram of the structure of the terminal device shown in FIG. 4, for example, FIG. 5 shows a specific structural form of the terminal device according to an embodiment of this application.

In some embodiments, a function of the processor 501 in FIG. 4 may be implemented by a processor 510 in FIG. 5.

In some embodiments, a function of the transceiver 503 in FIG. 4 may be implemented by using an antenna 1, an antenna 2, a mobile communication module 550, a wireless communication module 560, or the like in FIG. 5. The mobile communication module 550 may provide a solution that is applied to the terminal device and that includes a wireless communication technology such as LTE, NR, or future mobile communication. The wireless communication module 560 may provide a solution that is applied to the terminal device and that includes a wireless communication technology such as a WLAN (for example, a Wi-Fi network), Bluetooth (Bluetooth, BT), a global navigation satellite system (global navigation satellite system, GNSS), frequency modulation (frequency modulation, FM), near field communication (near field communication, NFC), or infrared. In some embodiments, the antenna 1 of the terminal device is coupled to the mobile communication module 550, and the antenna 2 is coupled to the wireless communication module 560, so that the terminal device can communicate with a network and another device by using a wireless communication technology.

In some embodiments, a function of the memory 502 in FIG. 4 may be implemented by using an internal memory 521, an external memory connected to an interface for external memory 520 in FIG. 5, or the like.

In some embodiments, a function of the output device 504 in FIG. 4 may be implemented by using a display 594 in FIG. 5.

In some embodiments, a function of the input device 505 in FIG. 4 may be implemented by using a mouse, a keyboard, a touchscreen device, or a sensor module 580 in FIG. 5.

In some embodiments, as shown in FIG. 5, the terminal device may further include one or more of an audio module 570, a camera 593, a button 590, a subscriber identity module (subscriber identity module, SIM) card interface 595, a universal serial bus (universal serial bus, USB) interface 530, a charging management module 540, a power management module 541, and a battery 542.

It may be understood that the structure shown in FIG. 5 does not constitute a specific limitation on the terminal device. For example, in some other embodiments of this application, the terminal device may include more or fewer components than those shown in the figure, or combine some of the components, or split some of the components, or have different layouts of the components. The components shown in the figure may be implemented by hardware, software, or a combination of software and hardware.

With reference to FIG. 1 to FIG. 5, the following describes the random access method provided in embodiments of this application in detail by using an example in which the network device 40 shown in FIG. 3 interacts with any terminal device 50.

It should be noted that names of messages between network elements, names of parameters in the messages, or the like in the following embodiments of this application are merely examples, and there may be other names in a specific implementation. This is not specifically limited in this embodiment of this application.

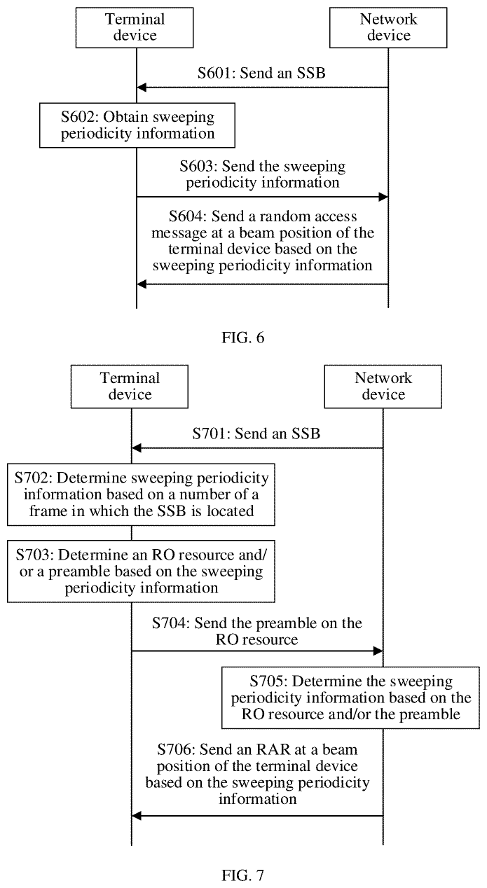

FIG. 6 shows a random access method according to an embodiment of this application. In FIG. 6, the method is described by using an example in which a network device and a terminal device are execution entities of the interaction example. However, the execution entities of the interaction example are not limited in this application. For example, the network device in FIG. 6 may alternatively be a chip, a chip system, or a processor that supports the network device in implementing the method, or may be a logical module or software that can implement all or some functions of the network device. The terminal device in FIG. 6 may alternatively be a chip, a chip system, or a processor that supports the terminal device in implementing the method, or may be a logical module or software that can implement all or some functions of the terminal device. The random access method includes the following steps.

S601: The network device sends a synchronization signal block (Synchronization Signal Block, SSB). Correspondingly, the terminal device receives the SSB. The SSB is a synchronization signal periodically sent by the network device in downlink, and is used by the terminal device to access the network device. The SSB may also be referred to as another name. This is not specifically limited in this embodiment of this application. The network device separately sends the SSB to one or more beam positions in one or more broadcast sweeping periodicities. The terminal device receives the SSB at a beam position of the terminal device.

S602: The terminal device obtains sweeping periodicity information, where the sweeping periodicity information includes a sequence number of an SSB burst set (burst set) to which the SSB received by the terminal device belongs. The sequence number may alternatively be an index. In other words, the sweeping periodicity information includes a periodicity number of a sweeping periodicity in which the SSB is located. The sweeping periodicity information may be used for determining a time period in which the terminal device receives the SSB. It may be understood that the network device may send different pieces of sweeping periodicity information in different sweeping periodicities, and different terminal devices may respectively obtain sweeping periodicity information corresponding to the terminal devices.

The SSB burst set is a set of one or more SSBs. The SSB burst set may also be referred to as another name. This is not specifically limited in this embodiment of this application.

The sweeping periodicity information may be represented by k bits, where k is an integer greater than or equal to 1. For example, if k=2, and the periodicity number is represented by two bits, a value set of the sweeping periodicity information is {00, 01, 10, 11}, and a value 01 indicates that the number of the periodicity in which the SSB is located is 1. For another example, if k=3, and the periodicity number is represented by three bits, a value set of the sweeping periodicity information is {000, 001, 010, 011, 100, 101, 110, 111}, and a value 001 indicates that the number of the periodicity in which the SSB is located is 1. A value of the sweeping periodicity information may represent the periodicity number, or an index of the periodicity number.

S603: The terminal device sends the sweeping periodicity information. Correspondingly, the network device obtains the sweeping periodicity information.

It may be understood that, although the sweeping periodicity information sent by the terminal device is obtained from the network device, the network device may generate one or more pieces of sweeping periodicity information, and the network device does not know which piece of sweeping periodicity information corresponds to the terminal device. In this case, the terminal device needs to send the sweeping periodicity information, so that the network device determines the sweeping periodicity information corresponding to the terminal device.

It may be understood that a representation form of the sweeping periodicity information sent by the terminal device may be different from that of the sweeping periodicity information sent by the network device to the terminal device. For example, the sweeping periodicity information sent by the network device to the terminal device is the sequence number of the SSB burst set, and the sweeping periodicity information sent by the terminal device is the index of the sequence number of the SSB burst set.

S604: The network device sends a random access message at the beam position of the terminal device based on the sweeping periodicity information.

Specifically, in an existing protocol, the network device knows a corresponding beam when sending the SSB to the terminal device. In other words, the network device knows a position of the terminal device relative to the network device when sending the SSB. However, because the network device may move, the beam no longer corresponds to the terminal device, and the terminal device cannot receive a message that is still sent on the beam. Time at which the SSB is sent may be determined based on the sweeping periodicity information. A current position of the terminal device relative to the network device may be obtained based on a position of the network device when the SSB is sent. In other words, an actual beam position of the terminal device is obtained. A message is sent at the actual beam position of the terminal device, and the terminal device can receive the message, so that random access is performed smoothly.

The random access message may be an RAR, a contention resolution message, a MsgB, a Msg2, or a Msg4 that is specified in an existing protocol, or another interaction message used for a random access procedure. This is not specifically limited in this embodiment of this application.

The foregoing embodiment may further include step S605: The network device sends an RAR at a plurality of possible beam positions corresponding to the terminal device.

The RAR is a response of the network device to a random access message (for example, a Msg1) sent by the terminal device. The RAR may also be referred to as another name. This is not specifically limited in this embodiment of this application.

When the sweeping periodicity information is not obtained, the network device cannot determine the beam position of the terminal device. The RAR is sent to the plurality of possible beam positions, so that a probability that the terminal device receives the RAR can be increased. Optionally, if the RAR is sent at all of the possible beam positions corresponding to the terminal device, it can be ensured that the RAR is sent to the beam position of the terminal device. For example, the network device has three sweeping periodicities: 1, 2, and 3. When the network device sends the RAR, if the sweeping periodicity corresponding to the SSB received by the terminal device is 1, the terminal device is at a beam position 1; if the sweeping periodicity corresponding to the SSB received by the terminal device is 2, the terminal device is at a beam position 2; or if the sweeping periodicity corresponding to the SSB received by the terminal device is 3, the terminal device is at a beam position 3. The network device separately sends the RAR at the beam positions 1, 2, and 3, and the sent RAR can cover the terminal regardless of the beam position of the terminal.

Sequence numbers of steps in this embodiment of this application do not indicate an implementation sequence. For example, S605 may be implemented before S603. An implementation sequence is not limited in this embodiment of this application.

That the terminal device obtains the sweeping periodicity information in step S602 may have a plurality of implementations. The following shows three possible implementations.

Implementation 1: The sweeping periodicity information is determined based on a number of a frame in which the SSB is located.

In other words, the number of the frame includes the sweeping periodicity information. Different sequence numbers of the SSB burst set correspond to different numbers of the frame. Therefore, the sweeping periodicity information may be determined based on the number of the frame. Because the number of the frame is existing information, the sweeping periodicity information does not need to be additionally sent. In this way, information transmission and interaction can be reduced.

Optionally, the sweeping periodicity information is determined based on n least significant bits of the number of the frame in which the SSB is located, where n is an integer greater than or equal to 1. For example, the sweeping periodicity information includes periodicity numbers 1, 2, 3, . . . , and 2\hat{ }k, which respectively correspond to numbers of the frame 1, 3, 5, . . . , and 2\hat{ }(k+1)−1, and the sweeping periodicity information can be determined based on information about k+1 least significant bits of the number of the frame. In this implementation, less information is required for determining the sweeping periodicity, and overheads are reduced.

Optionally, the sweeping periodicity information is the n least significant bits of the number of the frame in which the SSB is located. In this implementation, the sweeping periodicity information can be directly obtained.

Optionally, the sweeping periodicity information is determined based on other information that is in the SSB and that may be used for distinguishing between different sweeping periodicities.

Implementation 2: The network device sends the sweeping periodicity information. Correspondingly, the terminal device receives the sweeping periodicity information.

Optionally, the network device broadcasts configuration information used by the terminal device to perform random access. The configuration information carries the sweeping periodicity information. In other words, the sweeping periodicity information is carried in a broadcast message. Optionally, the network device sends the sweeping periodicity information to the terminal device by broadcasting a system information block SIB. In other words, the sweeping periodicity information is carried in the SIB broadcast by the network device. For example, the sweeping periodicity information may be carried in a system information block 1 (system information block 1, SIB1) and a system information block 19 (system information block 19, SIB19) that are broadcast by the network device. In this implementation, a sending manner and a representation form of the sweeping periodicity information may be flexibly selected.

Implementation 3: The network device sends the RAR, where the sweeping periodicity information is implicitly indicated in the RAR. Correspondingly, the terminal device receives the RAR, and determines the sweeping periodicity information based on the RAR. In the implicit indication manner, the sweeping periodicity information does not need to be additionally sent, so that information transmission and interaction can be reduced.

Specifically, the RAR sent by the network device is scrambled based on a random access radio network temporary identifier (random access radio network temporary identifier, RA-RNTI) and the sweeping periodicity information. The terminal device descrambles the RAR based on a possible value of the sweeping periodicity information and the RA-RNTI, and determines the sweeping periodicity information based on a descrambling result.

The RA-RNTI identifies a specific time-frequency resource used by a MAC entity for transmission of a random access preamble. The RA-RNTI may also be referred to as another name. This is not specifically limited in this embodiment of this application. For example, RA-RNTI=1+s_id+14×t_id+14×80×f_id+14×80×8×ul_carrier_id, where s_id represents a 1^{st} symbol of a PRACH time-frequency resource, t_id represents a 1^{st} slot of the PRACH time-frequency resource, f_id represents a frequency domain number of the PRACH time-frequency resource, ul_carrier_id represents an uplink carrier, a value 0 represents a primary carrier, and a value 1 represents a supplementary uplink (supplementary uplink, SUL) carrier.

There may be a plurality of implementations for scrambling. The following shows two possible implementations.

Implementation (1): Indicate the sweeping periodicity information based on a scrambling value.

Specifically, a value of the RA-RNTI may be offset, and RA-RNTI+i is used for scrambling, where i is determined based on the sweeping periodicity information. Correspondingly, the terminal device descrambles the RAR based on RA-RNTI+i, and determines the sweeping periodicity information based on a value of i that is for successful descrambling. It may be understood that the terminal device knows the RA-RNTI, and knows a value range of i. The terminal device attempts to separately perform, by using each possible value of i, descrambling based on RA-RNTI+i. If the descrambling succeeds, the value of i is correct. For example, the terminal device separately performs descrambling by using RA-RNTI+1, RA-RNTI+2, and RA-RNTI+3. If the descrambling succeeds by using RA-RNTI+3, it is considered that i=3. If i directly represents the sweeping periodicity information, the sweeping periodicity information is 3. i may be the sweeping periodicity information, or an index of the sweeping periodicity information. The value range of i may be pre-agreed upon by the network device and the terminal device, or may be determined by the network device and sent to the terminal device, or may be determined by the terminal device and sent to the network device.

Implementation (2): Indicate the sweeping periodicity information based on a scrambling position.

Specifically, the RAR is scrambled from a j^{th} bit based on the RA-RNTI, where j is determined based on the sweeping periodicity information. Correspondingly, the terminal device descrambles the RAR from the j^{th} bit based on the RA-RNTI, and determines the sweeping periodicity information based on a value of j that is for successful scrambling. It may be understood that the terminal device knows the RA-RNTI, and knows a value range of j. The terminal device attempts to separately perform, by using each possible value of j, descrambling from the j^{th} bit based on the RA-RNTI. If the descrambling succeeds, the value of j is correct.

In an existing protocol, for example, in 5G NR, an RA-RNTI has 16 bits, and cyclic redundancy check (cyclic redundancy check, CRC) of a physical downlink control channel (Physical Downlink Control Channel, PDCCH) associated with an RAR has 24 bits. The RA-RNTI is for scrambling last 16 bits of the CRC. In other words, scrambling based on the RA-RNTI starts from a 16^{th}-to-last bit of the CRC.

In this embodiment of this application, the scrambling position is determined based on the sweeping periodicity information, and the scrambling starts from the j^{th} bit. j may be the sweeping periodicity information, or an index of the sweeping periodicity information, or a calculation formula including the sweeping periodicity information. For example, based on the foregoing 5G NR scenario, the scrambling may start from a (16+k)^{th} bit, where k is the sweeping periodicity information. The value range of j may be pre-agreed upon by the network device and the terminal device, or may be determined by the network device and sent to the terminal device, or may be determined by the terminal device and sent to the network device.

The foregoing two scrambling implementations may alternatively be used in combination. In this case, the scrambling value and the scrambling position jointly indicate the sweeping periodicity information.

That the terminal device sends the sweeping periodicity information in step S603 may have a plurality of implementations. The following shows two possible implementations.

Implementation 1: The terminal device sends a preamble (preamble) on a random access channel occasion (random access channel occasion, RO) resource, where the RO resource and/or the preamble are/is determined based on the sweeping periodicity information. Correspondingly, the network device receives the preamble on the RO resource, and the sweeping periodicity information is determined based on the RO resource and/or the preamble. The sweeping periodicity information is implicitly indicated by using the RO resource and/or the preamble, and the sweeping periodicity information does not need to be additionally sent, so that information transmission and interaction can be reduced.

Different possible values of the sweeping periodicity information respectively correspond to different subsets of a set including available RO resources and/or a set including available preambles, and the subsets do not overlap. The value of the sweeping periodicity information is one of the different possible values of the sweeping periodicity information, and the RO resource and/or the preamble belong/belongs to a subset corresponding to the value of the sweeping periodicity information.

Specifically, a set of available RO resources is C, a value of an i^{th} piece of sweeping periodicity information corresponds to a subset Ci of the RO resource set C, and Ci includes at least one RO resource, where i=1, 2, . . . , M. M is a quantity of values of the sweeping periodicity information. An RO resource is selected from Ci. Alternatively, a set of available preambles is D, a value of an i^{th} piece of sweeping periodicity information corresponds to a subset Di of the preamble set D, Di includes at least one preamble, and a preamble is selected from Di. Alternatively, a value of an i^{th} piece of sweeping periodicity information corresponds to Ci and Di, and an RO resource is selected from Ci and a preamble is selected from Di. It may be understood that, for different values of i, Ci may include different quantities of RO resources. A part of the RO resources in the set C may not correspond to any value of the sweeping periodicity information. In other words, a union set P of RO resources corresponding to all values of the sweeping periodicity information is less than or equal to the set C. Similarly, Di may include different quantities of preambles, and a union set Q of preambles corresponding to all values of the sweeping periodicity information is less than or equal to the set D. It may be understood that if the RO resource is not determined based on the sweeping periodicity information, an RO resource is selected from the RO resource set C; or if the preamble is not determined based on the sweeping periodicity information, a preamble is selected from the preamble set D. For a specific implementation, refer to an existing protocol. Details are not described herein.

For example, a parameter ssb-perRACH-Occasion represents a quantity of SSBs corresponding to each RO. In a scenario in which the parameter ssb-perRACH-Occasion≥1, there are fewer available RO resources, and the preamble is determined based on the sweeping periodicity information. In a scenario in which the parameter ssb-perRACH-Occasion<1, there are more available RO resources, and the RO resource is determined based on the sweeping periodicity information.

In a scenario in which the RO resource is determined based on the sweeping periodicity information, RO resource subsets Ci corresponding to values of the sweeping periodicity information do not overlap with each other, and do not include a same element. The value of the sweeping periodicity information may be determined based on a subset to which the selected RO resource belongs. For example, the sweeping periodicity information has 2\hat{ }k values in total, the RO resource set C includes 2\hat{ }(k+1) RO resources, and every two RO resources are used as a subset. A subset corresponds to a 1^{st} value of the sweeping periodicity information includes a 1^{st} RO resource and a 2^{nd} RO resource, a subset corresponds to a 2^{nd} value of the sweeping periodicity information includes a 3^{rd} RO resource and a 4^{th} RO resource, . . . , and a subset corresponds to a (2\hat{ }k)^{th} value of the sweeping periodicity information includes a (2\hat{ }(k+1)−1)^{th} RO resource and a (2\hat{ }(k+1))^{th} RO resource. If the selected RO resource is the 3^{rd} RO resource, it may be determined that the value of the sweeping periodicity information is the 2^{nd} value.

Similarly, in a scenario in which the preamble is determined based on the sweeping periodicity information, preamble subsets Di corresponding to values of the sweeping periodicity information do not overlap with each other, and do not include a same element. The value of the sweeping periodicity information may be determined based on a subset to which the selected preamble belongs.

In a scenario in which the RO resource and the preamble are determined based on the sweeping periodicity information, for different values i, a value in the RO resource subset Ci and a value in the preamble subset Di form a value pair, all possible value pairs formed based on Ci and Di form a set Ei. Ei corresponding to the values of the sweeping periodicity information do not overlap with each other. The value of the sweeping periodicity information may be determined based on a subset to which the selected RO resource belongs and a subset to which the selected preamble belongs. For example, the value range of the sweeping periodicity information is {1, 2, 3, 4}, the RO resource set C includes two RO resources, and the preamble set D includes two preambles. The value 1 of the sweeping periodicity information corresponds to a 1^{st} RO resource and a 1^{st} preamble, the value 2 of the sweeping periodicity information corresponds to the 1^{st} RO resource and a 2^{nd} preamble, the value 3 of the sweeping periodicity information corresponds to a 2^{nd} RO resource and the 1^{st} preamble, and the value 4 of the sweeping periodicity information corresponds to the 2^{nd} RO resource and the 2^{nd} preamble.

Optionally, values of a plurality of pieces of sweeping periodicity information may be grouped together, and a group of values corresponds to a same RO resource subset and/or a same preamble subset. A value group of the sweeping periodicity information may be determined based on the subset to which the selected RO resource belongs and/or the subset to which the selected preamble belongs. In this way, the values of the sweeping periodicity information may be partially distinguished.

A correspondence between the sweeping periodicity information and the RO resource and/or the preamble may be pre-agreed upon by the network device and the terminal device, or may be determined by the network device and sent to the terminal device, or may be determined by the terminal device and sent to the network device, or may be defined in a protocol.

Implementation 2: Directly send the sweeping periodicity information. In this implementation, a sending manner and a representation form of the sweeping periodicity information may be flexibly selected.

Optionally, the sweeping periodicity information is carried in a Msg3.

It may be understood that the implementations of the foregoing steps may be combined with each other without a conflict. The following shows three possible combination manners.

FIG. 7 shows a random access method according to an embodiment of this application.

S701: A network device sends an SSB. Correspondingly, a terminal device receives the SSB.

S702: The terminal device determines sweeping periodicity information based on a number of a frame in which the SSB is located.

S703: The terminal device determines an RO resource and/or a preamble based on the sweeping periodicity information.

S704: The terminal device sends the preamble on the RO resource. Correspondingly, the network device receives the preamble on the RO resource.

S705: The network device determines the sweeping periodicity information based on the RO resource and/or the preamble.

S706: The network device sends an RAR at a beam position of the terminal device based on the sweeping periodicity information. Correspondingly, the terminal device receives the RAR.

Optionally, this embodiment of this application may further include the following steps.

S707: The terminal device sends a Msg3. Correspondingly, the network device receives the Msg3.

S708: The network device sends a Msg4 at the beam position of the terminal device. Correspondingly, the terminal device receives the Msg4.

FIG. 8 shows a random access method according to an embodiment of this application.

S801: A network device sends an SSB. Correspondingly, a terminal device receives the SSB.

S802: The network device sends sweeping periodicity information. Correspondingly, the terminal device receives the sweeping periodicity information.

S803: The terminal device sends a preamble. Correspondingly, the network device receives the preamble.

S804: The network device sends an RAR at a plurality of possible beam positions corresponding to the terminal device. Correspondingly, the terminal device receives the RAR.

S805: The terminal device sends a Msg3, where the Msg3 carries the sweeping periodicity information. Correspondingly, the network device receives the Msg3.

S806: The network device sends a Msg4 at a beam position of the terminal device based on the sweeping periodicity information. Correspondingly, the terminal device receives the Msg4.

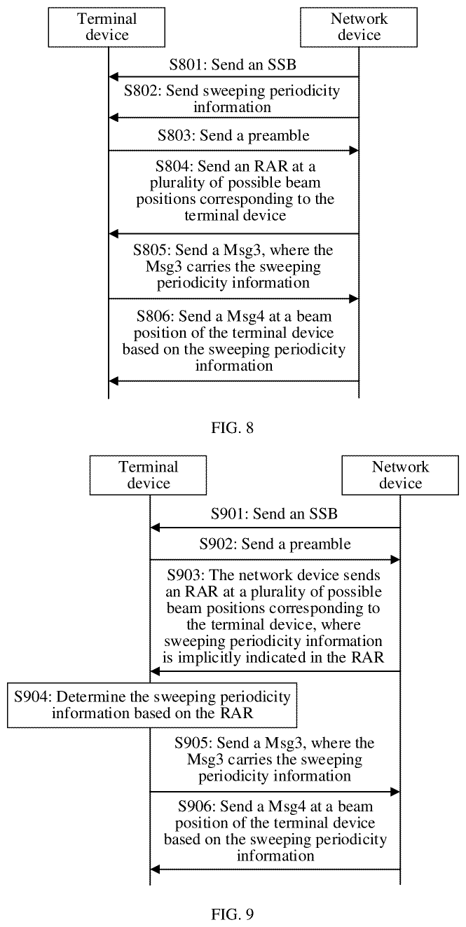

FIG. 9 shows a random access method according to an embodiment of this application.

S901: A network device sends an SSB. Correspondingly, a terminal device receives the SSB.

S902: The terminal device sends a preamble. Correspondingly, the network device receives the preamble.

S903: The network device sends an RAR at a plurality of possible beam positions corresponding to the terminal device, where sweeping periodicity information is implicitly indicated in the RAR. Correspondingly, the terminal device receives the RAR.

S904: The terminal device determines the sweeping periodicity information based on the RAR.

S905: The terminal device sends a Msg3, where the Msg3 carries the sweeping periodicity information. Correspondingly, the network device receives the Msg3.

S906: The network device sends a Msg4 at a beam position of the terminal device based on the sweeping periodicity information. Correspondingly, the terminal device receives the Msg4.

For detailed descriptions of the foregoing steps, refer to the embodiment shown in FIG. 6. Details are not described herein again.

It may be understood that embodiments of this application may be compatible with an existing protocol. In a scenario in which the network device is stationary, for example, for a ground base station, steps related to the sweeping periodicity information may be omitted, and random access is performed according to the existing protocol.

The foregoing mainly describes the solutions provided in embodiments of this application from a perspective of interaction between the devices. Correspondingly, an embodiment of this application further provides a communication apparatus, and the communication apparatus is configured to implement the foregoing methods. The communication apparatus may be the terminal device in the foregoing method embodiments. The terminal device herein may be the terminal device itself, or may be a processor, a module, a chip, a chip system, or the like that is in the terminal device and that implements the method. Alternatively, the communication apparatus may be the network device in the foregoing method embodiments. The network device herein may be the network device itself, or may be a processor, a module, a chip, a chip system, or the like that is in the network device and that implements the method. It may be understood that, to implement the foregoing functions, the communication apparatus includes a hardware structure and/or a software module for performing a corresponding function. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that in embodiments of this application, module division is an example, and is merely a logical function division. In actual implementation, another division manner may be used.

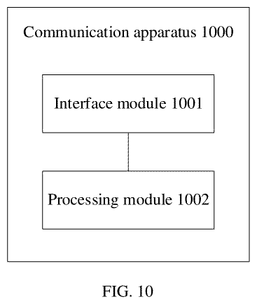

FIG. 10 is a diagram of a structure of a communication apparatus 1000. The communication apparatus 1000 includes an interface module 1001 and a processing module 1002. The interface module 1001 is configured to implement a transceiver function, and may be, for example, a transceiver circuit, a transceiver machine, a transceiver, or a communication interface.

An example in which the communication apparatus is the terminal device in the foregoing method embodiment is used, in a possible design, the interface module 1001 is configured to receive a synchronization signal block SSB. The processing module 1002 is configured to obtain sweeping periodicity information. The sweeping periodicity information includes a sequence number of an SSB burst set to which the SSB belongs. The interface module 1001 is further configured to send the sweeping periodicity information.

In a possible design, the sweeping periodicity information is determined based on a number of a frame in which the SSB is located.

In a possible design, the sweeping periodicity information is determined based on n least significant bits of a number of a frame in which the SSB is located, where n is an integer greater than or equal to 1.

In a possible design, the sweeping periodicity information is the n least significant bits of the number of the frame in which the SSB is located, where n is an integer greater than or equal to 1.

In a possible design, obtaining the sweeping periodicity information includes: the sweeping periodicity information is carried in a broadcast message.

In a possible design, the broadcast message is a system information block SIB, for example, a SIB1 or a SIB19.

In a possible design, obtaining the sweeping periodicity information includes: receiving a random access response message; and determining the sweeping periodicity information based on the random access response message.

In a possible design, determining the sweeping periodicity information based on the random access response message includes: descrambling the random access response message based on a possible value of the sweeping periodicity information and a random access radio network temporary identifier RA-RNTI, and determining the sweeping periodicity information based on a descrambling result.

In a possible design, descrambling the random access response message based on the possible value of the sweeping periodicity information and the RA-RNTI, and determining the sweeping periodicity information based on the descrambling result include: descrambling the random access response message based on RA-RNTI+i, where i is determined based on the possible value of the sweeping periodicity information; and determining the sweeping periodicity information based on a value of i that is for successful descrambling.

In a possible design, descrambling the random access response message based on the possible value of the sweeping periodicity information and the RA-RNTI, and determining the sweeping periodicity information based on the descrambling result include: descrambling the random access response message from a j^{th} bit based on the RA-RNTI, where j is determined based on the possible value of the sweeping periodicity information; and determining the sweeping periodicity information based on a value of j that is for successful descrambling.

In a possible design, sending the sweeping periodicity information includes: sending a preamble on a random access channel occasion resource, where the random access channel occasion resource and/or the preamble are/is determined based on the sweeping periodicity information.

In a possible design, that the random access channel occasion resource and/or the preamble are/is determined based on the sweeping periodicity information includes: different possible values of the sweeping periodicity information respectively correspond to different subsets of a set including available random access channel occasion resources and/or a set including available preambles, where the subsets do not overlap; and the value of the sweeping periodicity information is one of the different possible values of the sweeping periodicity information, and the random access channel occasion resource and/or the preamble belong/belongs to the subset corresponding to the value of the sweeping periodicity information.

In a possible design, sending the sweeping periodicity information includes: the sweeping periodicity information is carried in a message 3 (Msg3).

In this embodiment, the communication apparatus 1000 is presented in the form of functional modules obtained through integration. The module herein may be an ASIC, a circuit, a processor that executes one or more software or firmware programs, a memory, an integrated logic circuit, and/or another component capable of providing the foregoing functions.

In a simple embodiment, a person skilled in the art may figure out that the communication apparatus 1000 may be in a form of the terminal device shown in FIG. 4.

For example, the processor 501 in the terminal device shown in FIG. 4 may invoke the computer-executable instructions stored in the memory 502, so that the terminal device performs the random access method in the foregoing method embodiment. Specifically, functions/implementation processes of the interface module 1001 and the processing module 1002 in FIG. 10 may be implemented by using the processor 501 in the terminal device shown in FIG. 4 by invoking the computer-executable instructions stored in the memory 502. Alternatively, functions/implementation processes of the processing module 1002 in FIG. 10 may be implemented by using the processor 501 in the terminal device shown in FIG. 4 by invoking the computer-executable instructions stored in the memory 502, and functions/implementation processes of the interface module 1001 in FIG. 10 may be implemented by using the transceiver 503 in the terminal device shown in FIG. 4.

Because the communication apparatus 1000 provided in this embodiment can perform the foregoing random access method, for technical effects that can be obtained by the communication apparatus 1000, refer to the foregoing method embodiment. Details are not described herein again.

An example in which the communication apparatus is the network device in the foregoing method embodiment is used, in a possible design, the processing module 1002 is configured to obtain first sweeping periodicity information, where the first sweeping periodicity information includes a sequence number of an SSB burst set to which a first synchronization signal block SSB belongs. The interface module 1001 is configured to send a random access message at a beam position of the terminal device based on the first sweeping periodicity information. The first SSB is an SSB received by the terminal device.

In a possible design, the interface module 1001 is further configured to send second sweeping periodicity information. The second sweeping periodicity information includes a sequence number of an SSB burst set to which a second SSB belongs, and the first sweeping periodicity information is determined based on one of one or more pieces of second sweeping periodicity information. The first SSB is one of one or more second SSBs. The second SSB is an SSB sent by the network device.

In a possible design, sending the second sweeping periodicity information includes: sending the second SSB, where the second sweeping periodicity information is included in a number of a frame in which the SSB is located.

In a possible design, sending the second sweeping periodicity information includes: sending the second SSB, where the second sweeping periodicity information is included in n least significant bits of the number of the frame in which the SSB is located, and n is an integer greater than or equal to 1.

In a possible design, sending the second sweeping periodicity information includes: sending the second SSB, where the second sweeping periodicity information is the n least significant bits of the number of the frame in which the SSB is located, and n is an integer greater than or equal to 1.

In a possible design, the second sweeping periodicity information is carried in a broadcast message.

In a possible design, the broadcast message is a system information block SIB, for example, a SIB1 or a SIB19.

In a possible design, obtaining the first sweeping periodicity information includes: receiving a preamble on a random access channel occasion resource; and determining the first sweeping periodicity information based on the random access channel occasion resource and/or the preamble.

In a possible design, determining the first sweeping periodicity information based on the random access channel occasion resource and/or the preamble includes: different possible values of the first sweeping periodicity information respectively correspond to different subsets of a set including available random access channel occasion resources and/or a set including available preambles, where the subsets do not overlap; and determining the first sweeping periodicity information based on the subset to which the random access channel occasion resource belongs and/or the subset to which the preamble belongs.

In a possible design, the random access message is a random access response message and/or a message 4 (Msg4).

In a possible design, obtaining the first sweeping periodicity information includes: the first sweeping periodicity information is carried in a message 3 (Msg3).

In a possible design, the interface module 1001 is further configured to send a random access response message at a plurality of possible beam positions corresponding to the terminal device.

In a possible design, sending the second sweeping periodicity information includes: sending a random access response message at a plurality of possible beam positions corresponding to the terminal device, and scrambling the random access response message based on a random access radio network temporary identifier RA-RNTI and the second sweeping periodicity information.

In a possible design, scrambling the random access response message based on the RA-RNTI and the second sweeping periodicity information includes: scrambling the random access response message by using RA-RNTI+i, where i is determined based on the second sweeping periodicity information.

In a possible design, scrambling the random access response message based on an RA-RNTI and the second sweeping periodicity information includes: scrambling the random access response message from a j^{th} bit by using the RA-RNTI, where j is determined based on the second sweeping periodicity information.

In this embodiment, the communication apparatus 1000 is presented in the form of functional modules obtained through integration. The module herein may be an ASIC, a circuit, a processor that executes one or more software or firmware programs, a memory, an integrated logic circuit, and/or another component capable of providing the foregoing functions.

In a simple embodiment, a person skilled in the art may figure out that the communication apparatus 1000 may be in a form of the network device shown in FIG. 4.

For example, the processor 401 in the network device shown in FIG. 4 may invoke the computer-executable instructions stored in the memory 402, so that the network device performs the random access method in the foregoing method embodiment. Specifically, functions/implementation processes of the interface module 1001 and the processing module 1002 in FIG. 10 may be implemented by using the processor 401 in the network device shown in FIG. 4 by invoking the computer-executable instructions stored in the memory 402. Alternatively, functions/implementation processes of the processing module 1002 in FIG. 10 may be implemented by using the processor 401 in the network device shown in FIG. 4 by invoking the computer-executable instructions stored in the memory 402, and functions/implementation processes of the interface module 1001 in FIG. 10 may be implemented by using the transceiver 403 in the network device shown in FIG. 4.

Because the communication apparatus 1000 provided in this embodiment can perform the foregoing random access method, for technical effects that can be obtained by the communication apparatus 1000, refer to the foregoing method embodiment. Details are not described herein again.

It should be noted that one or more of the foregoing modules or units may be implemented by using software, hardware, or a combination thereof. When any one of the foregoing modules or units is implemented by software, the software exists in a form of a computer program instruction, and is stored in the memory. The processor may be configured to execute the program instruction and implement the foregoing method procedure. The processor may be built into a SoC (System on Chip) or an ASIC, or may be an independent semiconductor chip. In addition to a core that is configured to execute software instructions to perform an operation or processing, the processor may further include a necessary hardware accelerator, for example, an FPGA, a programmable logic device (programmable logic device, PLD), or a logic circuit that implements a dedicated logic operation.

When the foregoing modules or units are implemented by using hardware, the hardware may be any one or any combination of a CPU, a microprocessor, a DSP chip, a microcontroller unit (microcontroller unit, MCU), an artificial intelligence processor, an ASIC, a SoC, an FPGA, a PLD, a dedicated digital circuit, a hardware accelerator, or a non-integrated discrete device, and the hardware may run necessary software or does not depend on software, to perform the foregoing method procedures.

Optionally, an embodiment of this application further provides a chip system, including at least one processor and an interface. When the at least one processor executes a computer program or instructions, the method in any one of the foregoing method embodiments is enabled to be performed. In a possible implementation, the communication apparatus further includes a memory, the memory stores a computer program or instructions, and the at least one processor is coupled to the memory by using an interface. Optionally, the chip system may include a chip, or may include a chip and another discrete device. This is not specifically limited in this embodiment of this application.

All or some of the foregoing embodiments may be implemented by using software, hardware, firmware, or any combination thereof. When a software program is used to implement embodiments, embodiments may be implemented completely or partially in a form of a computer program product.

This application provides a computer program product, including a computer program or instructions. When the computer program or the instructions are executed by a computer, any method in this embodiment of this application is enabled to be performed.

When the computer program instructions are loaded and executed on the computer, the procedure or functions according to this embodiment of this application are all or partially generated. The computer may be a general-purpose computer, a dedicated computer, a computer network, or another programmable apparatus.

The computer instructions may be stored in a computer-readable storage medium. An embodiment of this application provides a computer-readable storage medium. The computer-readable storage medium stores a computer program or instructions. When the computer program or the instructions are executed by a computer, any method in embodiments of this application is enabled to be performed.

The computer instructions may be transmitted from a computer-readable storage medium to another computer-readable storage medium. For example, the computer instructions may be transmitted from a website, a computer, a server, or a data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, such as a server or a data center, including one or more usable mediums. The usable medium may be a magnetic medium (for example, a floppy disk, a hard disk drive, or a magnetic tape), an optical medium (for example, a digital versatile disc (digital versatile disc, DVD)), a semiconductor medium (for example, a solid-state drive (solid-state drive, SSD)), or the like.

Although this application is described with reference to embodiments, in a process of implementing this application that claims protection, a person skilled in the art may understand and implement another variation of the disclosed embodiments by viewing the accompanying drawings, disclosed content, and appended claims. In the claims, “comprising” (comprising) does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a better effect.

Although this application is described with reference to specific features and embodiments thereof, it is clear that various modifications and combinations may be made to them without departing from the protection scope of this application. Correspondingly, the specification and accompanying drawings are merely example description of this application defined by the accompanying claims, and are considered as any of or all modifications, variations, combinations or equivalents that cover the scope of this application. This application is intended to cover these modifications and variations of this application provided that they fall within the scope of the claims of this application and equivalent technologies thereof.

1. A method, wherein the method comprises:
receiving a synchronization signal block SSB;
obtaining sweeping periodicity information, wherein the sweeping periodicity information comprises a sequence number of an SSB burst set to which the SSB belongs; and
sending the sweeping periodicity information.

2. The method according to claim 1, wherein the sweeping periodicity information is determined based on a number of a frame in which the SSB is located.

3. The method according to claim 1, wherein obtaining the sweeping periodicity information comprises: the sweeping periodicity information is carried in a broadcast message.

4. The method according to claim 1, wherein obtaining the sweeping periodicity information comprises:
receiving a random access response message; and
determining the sweeping periodicity information based on the random access response message.

5. The method according to claim 4, wherein determining the sweeping periodicity information based on the random access response message comprises:
descrambling the random access response message based on a possible value of the sweeping periodicity information and a random access radio network temporary identifier RA-RNTI, and determining the sweeping periodicity information based on a descrambling result.

6. The method according to claim 1, wherein sending the sweeping periodicity information comprises:
sending a preamble on a random access channel occasion resource, wherein the random access channel occasion resource and/or the preamble are/is determined based on the sweeping periodicity information;
wherein that the random access channel occasion resource and/or the preamble are/is determined based on the sweeping periodicity information comprises:
different possible values of the sweeping periodicity information respectively correspond to different subsets of a set comprising available random access channel occasion resources and/or a set comprising available preambles, and the subsets do not overlap; and
a value of the sweeping periodicity information is one of the different possible values of the sweeping periodicity information, and the random access channel occasion resource and/or the preamble belong/belongs to a subset corresponding to the value of the sweeping periodicity information.

7. The method according to claim 1, wherein sending the sweeping periodicity information comprises: the sweeping periodicity information is carried in a message 3.

8. An apparatus, comprising:
at least one processor; and
one or more memories coupled to the at least one processor and storing programming instructions for execution by the at least one processor to:
receive a synchronization signal block SSB;
obtain sweeping periodicity information, wherein the sweeping periodicity information comprises a sequence number of an SSB burst set to which the SSB belongs; and
send the sweeping periodicity information.

9. The apparatus according to claim 8, wherein the sweeping periodicity information is determined based on a number of a frame in which the SSB is located.

10. The apparatus according to claim 8, wherein the sweeping periodicity information is carried in a broadcast message.

11. The apparatus according to claim 8, wherein obtain the sweeping periodicity information comprises:
receive a random access response message; and
determine the sweeping periodicity information based on the random access response message.

12. The apparatus according to claim 11, wherein determine the sweeping periodicity information based on the random access response message comprises:
descramble the random access response message based on a possible value of the sweeping periodicity information and a random access radio network temporary identifier RA-RNTI, and determining the sweeping periodicity information based on a descrambling result.

13. The apparatus according to claim 8, wherein send the sweeping periodicity information comprises:
send a preamble on a random access channel occasion resource, wherein the random access channel occasion resource and/or the preamble are/is determined based on the sweeping periodicity information;
wherein that the random access channel occasion resource and/or the preamble are/is determined based on the sweeping periodicity information comprises:
different possible values of the sweeping periodicity information respectively correspond to different subsets of a set comprising available random access channel occasion resources and/or a set comprising available preambles, and the subsets do not overlap; and
a value of the sweeping periodicity information is one of the different possible values of the sweeping periodicity information, and the random access channel occasion resource and/or the preamble belong/belongs to a subset corresponding to the value of the sweeping periodicity information.

14. The apparatus according to claim 8, wherein the sweeping periodicity information is carried in a message 3.

15. An apparatus, comprising:
at least one processor; and
one or more memories coupled to the at least one processor and storing programming instructions for execution by the at least one processor to:
obtain first sweeping periodicity information, wherein the first sweeping periodicity information comprises a sequence number of a synchronization signal block SSB burst set to which a first SSB belongs; and
send a random access message at a beam position of a terminal device based on the first sweeping periodicity information.

16. The apparatus according to claim 15, wherein the one or more memories further storing programming instructions for execution by the at least one processor to:
send second sweeping periodicity information, wherein the second sweeping periodicity information comprises a sequence number of an SSB burst set to which a second SSB belongs, a sweeping periodicity corresponding to the first sweeping periodicity information is one of sweeping periodicities corresponding to one or more pieces of second sweeping periodicity information, and the first SSB is one of one or more second SSBs.

17. The apparatus according to claim 16, wherein send the second sweeping periodicity information comprises:
send the second SSB, wherein the second sweeping periodicity information is comprised in a number of a frame in which the second SSB is located.

18. The apparatus according to claim 16, wherein the second sweeping periodicity information is carried in a broadcast message;
wherein the broadcast message is a system information block SIB.

19. The apparatus according to claim 15, wherein obtain the first sweeping periodicity information comprises:
receive a preamble on a random access channel occasion resource; and
determine the first sweeping periodicity information based on the random access channel occasion resource and/or the preamble.

20. The apparatus according to claim 16, wherein send the second sweeping periodicity information comprises:
send a random access response message at a plurality of possible beam positions corresponding to the terminal device, and scrambling the random access response message based on a random access radio network temporary identifier RA-RNTI and the second sweeping periodicity information.
